(19) United States
(12) Patent Application Publication
(10) Pub. No.: US 2023/0267560 A1
(43) Pub. Date: Aug. 24, 2023

(54) FOOD ORDERING APPLICATION

(71) Applicant: Mindlab Inc., Thornhill (CA)

(72) Inventor: Fatameh Kazemi, Thornhill (CA)

(73) Assignee: Mindlab Inc., Thornhill (CA)

(21) Appl. No.: 17/652,344

(22) Filed: Feb. 24, 2022

(51) Int. Cl. G06Q 50/12

(52) U.S. Cl. CPC G06Q 50/12

(57) ABSTRACT

A software application that facilitates ordering of food wherein the food is categorized for the user utilizing parameters such as but not limited to health requirements and taste preferences. The present invention provides automated selection guidance for ordering food from restaurants wherein the restaurants are further identified employing categories and geographical distance from the user. The software application includes displaying food items to a user wherein the food items are categorized as allowed, restricted or prohibited wherein the aforementioned categories are a result of the profile parameters of the user. The present invention further provides a plurality of filters wherein the filters allow a user to segment the type of food and price that will be displayed to them. The software application further provides three food designations based on the user profile wherein the food designations are displayed in three different colors.

### FIELD OF THE INVENTION

The present invention relates generally to the food service industry, more specifically but not by way of limitation, a software application that facilitates food ordering wherein the food ordering is governed by health preferences and requirements of the individual ordering the food.

### BACKGROUND

Millions of people order food on a regular basis and either have the food delivered or go to the restaurant and pick up the food. Take-out cuisine has increased in popularity and is a main revenue stream even for traditional dine-in restaurants. While eating out is considered by many to either provide convenience or enjoyment, it does offer many challenges to the ordering consumer. Many people have food allergies and can sometimes not be aware of all of the ingredients in a prepared meal and as such undertake certain risks when ordering food. Additionally, there are numerous people that are on special diets or are afflicted with various diseases that require special nutritional needs.

One issue with individuals that are either afflicted with a particular disease that results in dietary restrictions or with those that are following dietary restrictions for other reasons is the difficulty in ascertaining which menu item is compliant with their dietary requirements. While traditional food ordering techniques provide information as to the type of cuisine, ingredients and sometimes basic nutritional information, they do no provide any insight as to compliance with particular diets or being allowed for consumption if the individual is afflicted with a particular disease. No existing food ordering system that is operably coupled to or a part of a restaurant ordering process provides a technique for a user to determine if the food is compliant with their dietary requirements. Currently, this requires a great deal of diligence from the ordering individual.

Accordingly, there is a need for a food ordering application that facilitates ordering of food from a plurality of restaurants wherein the present invention provides automated compliance with an individuals dietary restrictions and/or requirements.

### SUMMARY OF THE INVENTION

It is the object of the present invention to provide a food ordering software application embodied as a mobile and/or web application that facilitates the ordering of food wherein the food presented for order is filtered to the dietary requirements of the individual ordering wherein the present invention provides user registration that allows a user to select dietary needs.

Another object of the present invention is to provide a food ordering application that provides the ability to order food compliant with at least one dietary requirement wherein the present invention includes the providing of a plurality of known diseases and will filter available food from restaurants that can be consumed by individuals afflicted with one of the diseases.

A further object of the present invention is to provide a food ordering software application embodied as a mobile and/or web application that facilitates the ordering of food wherein the food presented for order is filtered to the dietary requirements of the individual ordering wherein the present invention groups available food items into three categories.

Still another object of the present invention is to provide a food ordering application that provides the ability to order food compliant with at least one dietary requirement wherein the present invention further accommodates taste preferences and integrates with compliant food items to be made available to the consumer.

An additional object of the present invention is to provide a food ordering software application embodied as a mobile and/or web application that facilitates the ordering of food wherein the food presented for order is filtered to the dietary requirements of the individual ordering wherein during the user registration process the software will provide a list of diseases, allergenic ingredients, associated food restrictions and additional data from which the user can select and make part of their profile.

Yet a further object of the present invention is to provide a food ordering application that provides the ability to order food compliant with at least one dietary requirement wherein the present invention further allows the user to prioritize restaurants and food choices by location.

Another object of the present invention is to a provide a food ordering software application embodied as a mobile and/or web application that facilitates the ordering of food wherein the food presented for order is filtered to the dietary requirements of the individual ordering wherein the three categories can further be segmented by visual indicators such as but not limited to a color scheme.

An alternate object of the present invention is to provide a food ordering application that provides the ability to order food compliant with at least one dietary requirement wherein the software application further includes a dashboard for an administrative operator and the restaurant operator that facilitates management of a plurality of tasks.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a flowchart diagram of an administrative operator process of the present invention; and

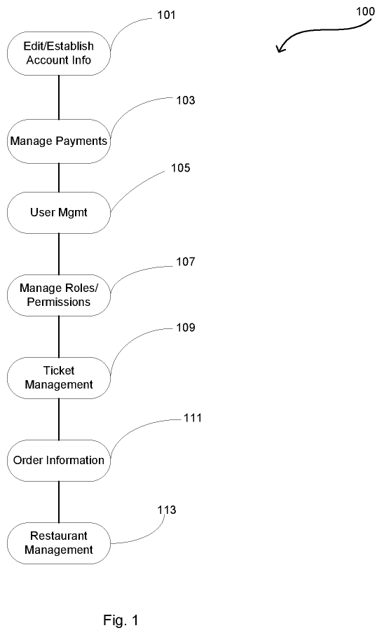

FIG. 2 is a flowchart diagram of the user process of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a food ordering application 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the food ordering application 100 is controlled by an operative administrator that performs key functions such as but not limited to problems of the system users that include both customer users and restaurant provider issues. The operative administrator utilizes a conventional graphical dashboard interface to execute the required tasks. In step 101, the operative administrator performs various user account maintenance and/or corrective actions. The operative administrator can edit their information, which includes parameter fields such as but not limited to full name, phone number, email. Password management can also further be executed via the dashboard interface. In step 103, the operative administrator accesses a payments page, which is a conventional graphical software interface, by selecting the payment option. Utilization of the payments page facilitates the ability for the operative administrator to manage payment details that include but are not limited to the customer's name, amount, restaurant name, payment's date and time, and payment status. Report generation of all of the immediately aforementioned can further be performed by the operative administrator.

Step 105, the operative administrator will perform management of users and their roles and the data pertaining thereto. By way of example but not limitation, this step includes the following. The operative administrator performs all of the activities related to user management in this step. A list of all users can be extracted from a database and is displayed to the operative administrator in accordance with order of username. Additionally, a list of system's roles, which by selecting any of these roles, the displayed list of users is filtered based thereon. By way of example but not limitation, when the operative administrator selects the role of customer and agent, a list of users who have the role of customer or agent is displayed. By selecting any user, the operative administrator can execute tasks such as but not limited to the following for the selected user. The operative administrator can edit all the information of the desired user including name, surname, contact number, email address. Furthermore, the operative administrator can enable or disable the selected user. The operative administrator can reset the password of the selected user. The operative administrator can further assign new roles to the selected user or remove roles therefrom. Additionally, the operative administrator can create a new user by utilizing a add new user button. This information includes: first name, last name, contact number, email address, username and password. Moreover, from the list of roles in the system, the selected roles will be assigned to the new user.

In step 107, the operative administrator executes a plurality of roles and permissions for the entities that interface and utilize the software application of the present invention. In this step, the operative administrator manages the existing roles in the system and can assign permissions, remove permissions or define new roles in the system. The list of roles and permissions in the system is extracted from the system database. Currently within the scope of the present invention the following roles exist within the present invention: customer, admin system, restaurant agent, courier, co-worker.

In step 109 the operative administrator will perform various ticket management tasks such as but not limited to the following. The ticket management interface of the present invention includes three sections: not open tickets, tickets and my tickets. Selection of tickets, the operative administrator enters a page where all the tickets registered in the system can be viewed regardless of their status. A table is provided on this page where the ticket number, the name of the person who created the ticket and the role of that person in the system. Additionally, if the ticket is made by the restaurant, the name of the restaurant is also displayed in the table. The table further provides the time of creating the ticket, the priority of the ticket, the person reviewing the ticket and finally the status of the ticket. The software application allows each ticket to be drilled into wherein the operative administrator can read the information on that ticket, write a response to the ticket, or attach a file to that ticket and finally change the status of the ticket to closed. Furthermore, if the person registering the ticket has expressed his satisfaction with the way the ticket was answered, the operative administrator can also see the level of satisfaction. If the operative administrator selects the not open tickets section, the operative administrator can see all the tickets that have yet to receive a response. Selection of the my tickets section, the operative administrator can view all the tickets that the operative administrator has performed a task thereon, and see the details of each ticket.

In the system, each ticket can have one of three conditions. The first condition is not open. Not open occurs when a ticket is made but has not yet received a response. This situation continues until the ticket receives the first response from the operative administrator. The second condition is open. The status of an open ticket remains as long as the messages are exchanged and not explicitly closed by any of the creators or the operative administrator. The third ticket condition is closed. When the creator or operative administrator responds to a ticket, they can close the ticket. In this case, the ticket status will change from open to closed. It is possible for both the user and the customer to reopen the closed ticket. For this purpose, a ticket message should is transmitted by the person who reopens the ticket.

In step 111, the operative administrator can perform a multitude of order information management tasks. The operative administrator has access to in the system an orders option, through which interfacing therewith opens a page where there is a table with columns that show the order information. Through this table, the operative administrator can view order parameters such as but not limited to, the registered orders in the system, name and contact number of the person who registered the order, registration date, restaurant name, order status and serve type method, i.e., delivery by restaurant or pick up, as well as customer's feedback. If the operative administrator can drill down on any of the orders and view the information of that order, which includes the name of ordered food, the number of meals, the cost, and finally the general invoice.

In step 113, the operative administrator executes a plurality of tasks related to restaurant management. The operative administrator engages the restaurant option that is provided as a graphical interface and is provided an interface page having a first tab named new register restaurants and a second tab named restaurants. In the first tab, there is a table through which the operative administrator can view the name, contact number, serve type, and the status of the restaurants that have recently registered in the system and, if necessary, the operative administrator can accept them through the action column. Acceptance as a new restaurant for the present invention is contemplated to occur subsequent contacting the restaurant and performing restaurant's authentication. In the restaurants section, the operative administrator can view the information of all the approved restaurants including the restaurant agent information, restaurant's name, address, phone number, and serve type, as well as the feedback that customers have provided about that restaurant. It should be understood within the scope of the present invention that the customer feedback could be on an entire order or a specific item of an order. Additionally, by clicking on any of the restaurant graphical images, the restaurant information is displayed for the operative administrator and the operative administrator can edit the displayed fields. Through the menu image button, the operative administrator can edit the restaurant menu image, and through the menu maker button, the operative administrator can create menu and foods for the selected restaurant or edit the previous menu of that restaurant. Furthermore, the operative administrator can upload the restaurant photos or delete the previous photos via the restaurant image button and upload the logo for the restaurant or delete the previous restaurant's logo via the restaurant logo button. Selection of the restaurant image option, the operative administrator will be transferred to a page where the operative administrator can view all the photos uploaded by active restaurants in the system and depending on the system rules, can reject or accept those photos for displaying in the system.

The operative administrator selects the provided restaurant logo option to be transferred to a page where the operative administrator can view all the logos uploaded by active restaurants in the system and depending on the system rules, the operative administrator can reject or accept those photos for displaying in the system. Engaging the provided menu image option transfers the operative administrator to a page where the operative administrator can view all the menu photos uploaded by active restaurants in the system and depending on the system rules, the operative administrator can reject or accept those photos for displaying in the system. By selecting a provided food image option, the operative administrator will be transferred to a page where all the photos that active restaurants have uploaded of their foods in the system can be viewed and depending on the system rules, those photos will be rejected or accepted for displaying in the system by the operative administrator.

A cities page option is provided to the operative administrator wherein the operative administrator can view the names of all the cities in which the system provides services, and also the operative administrator can add the names of new cities to the system through the provided name field. The operative administrator clicks on the provided food type option to be directed to a page that the operative administrator can create a new food type. The operative administrator can also see all the pre-made food types and search the food type list via the search field. Additionally, the operative administrator also can add the name of the diseases, allergies, diets or different tastes not presently listed within the present invention. in the system. For example, if the system does not include Lupus disease this can be added along with the restrictions associated therewith. Selection of the provided ingredient type option, the operative administrator is directed to a page that operative administrator can create a new ingredient type. Also, the operative administrator can view the list of all created ingredient types, and search the list through the search field.

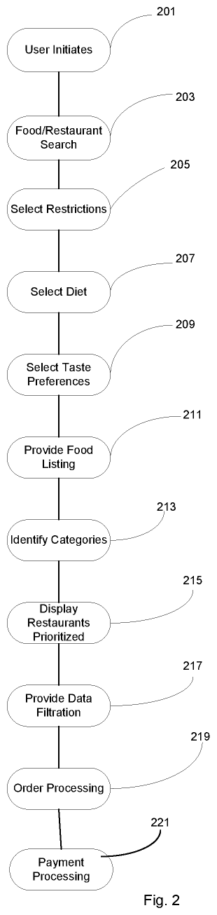

Now referring to FIG. 2 submitted as a part hereof, the user tasks and experiences are outlined therein wherein the foregoing provides details of the user experience of the food ordering application 100. It should be understood that while presented in a certain order the steps of the food ordering application 100 could be executed in alternate sequences or in isolation. It is further contemplated within the scope of the present invention that the main graphical interface page of the software application includes four main categories of: site name, login, sign up and register restaurant. In step 201, the user registration and tasks associated therewith is executed. In sign up the user first selects the sign up button on the main page and then a pop-up graphical interface is opened. In this graphical interface there is a box, which allows the user to register through social networks such as Gmail and Facebook. Next, a verification code is emailed or texted to the user, and after the verification code is successfully entered by the user, a page is displayed to the user, which contains the message that the user has registered successfully. If a user chooses to complete a user profile a wizard will open for the user to complete a profile and according to the information entered, the restaurants and foods will be searched intelligently for him. The completion of the profile is displayed to the user by a wizard, which receives information from the user in the following areas: profile, dietary, address, disease, disorder, allergy and taste. The profile and dietary information is entered into wizard. The user chooses a name for their profile that later in different sections of the site can use the information entered in his profile easily by searching for the profile name. In this section, the list of dietaries such as halal, kosher, vegetarian, not-salty, hot, diet, non-fatty, spicy, vegan and other dietary parameters are displayed from the database to the user, and they can select the dietaries in which they need.

Displayed on a second page of the wizard, the address information is received from the user. The address information is searchable through the map or the user can enter their exact address in the pre-specified fields. On a third page of the wizard, there are two sections, the list of diseases and disorders such as but not limited to cancers, autism, Covid-19 and others, are displayed in one input box and the list of the specific diets such as ketogenic, pescatarian, lacto vegetarianism and others are displayed in another input box to the user. The user can choose their limitations from among them. The present invention currently covers forty-one diseases, sixteen disorders and twelve diets but it should be understood within the scope of the present invention that more or less of each could be provided. The user can select any number of diseases, disorders and diets from the list. If the user's disease, disorder or diet is not found in the lists, the user can use a specified ticket section to send a ticket to the operative administrator of the present invention about adding their limitation. On a fourth page of the wizard, a list of allergenic ingredients is displayed to the user, so that the user can choose the ingredients to which they are allergic. The list of allergens is completely prepared by nutritionists and is available in the database of the present invention. The present invention includes two hundred and thirty five allergens and forty groups of allergens but it should be understood within the scope of the present invention that this could vary.

On the last page of the wizard component, a search for taste is displayed to the user, and the user can select the ingredients or ingredient types that the user doesn't like. A list of all ingredients and ingredient types is available in the database. It is possible for user to choose ingredients individually as well as in groups. For example, the user can select only butter from fat group or can choose the whole group of fat including butter, margarine, tahini and others. After choosing the ingredients and ingredient types, the user also can specify the amount of his dislike by clicking on two options, either I hate it or I like a little. Ingredient types are groups of raw materials that have common properties. These common properties help us to define more easily the rules related to each disease in our database. For example, dairy is an ingredient type that includes ingredients such as milk, yogurt, cheese, cream and others. If the dairy group is harmful to a particular disease, instead of defining the law for each dairy food, for example milk, yogurt, cheese, and others, a rule is defined for the dairy group, which means that all substances foods in this ingredient type such as milk, yogurt, and others are harmful to this particular disease. Each ingredient may belong to several ingredient types. Finally, the user clicks on the Finish button, and this profile is stored in the database and subsequently the search for restaurants is done intelligently based on the received information by the user. If a user refuses to complete the profile and do a restaurant search they will be directed to the main page.

In step 203, a user will search for food and/or restaurants. In the main page of the software application there is an address input box, where the user enters their address on it, and according to this address the system displays the list of the restaurants around to the user. For a more accurate search and further guidance of the user, as soon as the user starts typing his address the list of addresses is suggested to the user. In addition to entering the address manually by the user, it is also possible for user to use the current location service. The search of restaurants and foods is done in two ways, one is basic search and the other is healthy search. The user can choose one of the two ways, and the default has been set to healthy search. If the user selects basic search, according to the location entered, all restaurants that are within a certain radius of the entered location are displayed. The list of restaurants is extracted from our database where the exact addresses of the restaurants has stored. In healthy search, there are two modes, either the user is not logged in, or the user is logged in. If the user has not logged in, after specifying their location, by clicking on the healthy search button, four boxes will be shown to him. In the first box, the user can select a set of restrictions that include a list of diseases and disorders and in the second box the user can select diet from the displayed list. All of these lists have already been collected by nutritionists and stored in our system database. Our system currently covers forty-one diseases, sixteen disorders and twelve diets. The user can select any number of diseases, disorders and diets from the list. In the third box, the list of ingredients and ingredient types that are allergenic is extracted from system database, and displayed to the user. As a result, the user can select items that they are allergic to from this search box. Our system currently covers two hundred and thirty five allergens and forty groups of allergens.

In the fourth box, the user can select the ingredients or ingredient types that the user does not like. A list of all ingredients and ingredient types is available in the database. It is possible for user to choose ingredients individually as well as in groups. For example, the user can select only butter from fat group or can choose the whole group of fat including butter, margarine, tahini and others. After choosing the ingredients and ingredient types, the user also can specify the amount of his dislike by clicking on two options, either I hate it or I like a little. After this information is specified by the user, the rules that are already stored in the database are extracted and the search operation is performed based on the entered information as well as the user's location. Here, the search for food and restaurants is done by the central core of the present invention, which is based on our defined expert system. In the following we describe the search process without entering the health parameters and when the user has already entered this information into the system. If the user is logged in, and the user has already defined a profile for himself in the system. In this case, the list of user profiles is displayed and the user can select the desired profile. Once the user's profile is determined, information about his specified limitations as well as the defined rules for those limitations is extracted from the database, and the search operation is performed based on the health and taste information related to the selected profile and he user's location. Next to the list of profiles, another option is shown to the user, which if the user does not want to search foods and restaurants according to the given information in their profiles, by selecting that option, he will be directed to the wizard section to select the diseases, disorders, diets, allergens and taste, and search operation is done based on this information and the user's location. If the user has not defined a profile in the system, in this case, by clicking on the search button, the wizard will display the diseases, disorders, diets, allergens and tastes to the user. After specifying this information by the user, the entered information is stored as a user profile in the database, and after extracting the rules related the user's health parameters, the search operation is performed based on this information and the user's location.

In step 205, the user will select desired or recommended restrictions to be applied when utilizing the present invention. In a search process facilitated by the present invention restaurants that are proximate the user's location are identified. Additionally, the restaurants that serve food meeting the parameters of the user's health requirements and taste preferences are identified. The present invention categorizes the food that is displayed to the user into three categories: allowed, restricted, and prohibited. Allowed foods also referred to as healthy delicious are shown with green logo, restricted foods also referred to as carefree delicious are shown with orange logo, and prohibited foods also referred to as unkind delicious are shown in pink color. If the primary ingredient of the food is a prohibited substance for the user, or the user has an allergy to an ingredient in the food or the user has entered into their profile a dislike for the ingredient, no matter how much of this ingredient is used in the food, the food is categorized as ‘unkind delicious’ and is shown with the pink logo to the user. There are three options if the ingredient is a restricted ingredient for the user, or if the user's taste preference level has been entered into their profile to indicate their dislike but will tolerate consumption. If this ingredient is used sparingly in food, the food is categorized as healthy delicious and is displayed with the green logo to the user. If this ingredient is used in moderation in food, the food is categorized as carefree delicious and is displayed with the orange logo to the user. If this ingredient is used in large quantities in food, the food is categorized as unkind delicious and is displayed with the pink logo to the user. The list of restaurants is displayed first in the order of the greatest number of healthy or green dishes and then in the order of proximity to the location. The user can specify the order of displaying the restaurants according to healthiest, nearest or lowest preparation time.

In step 207 selection of dietary filters occurs. The present invention facilitates filtering the foods available from the restaurants according parameters such as: halal, kosher, vegetarian, sodium level, hot, diet, non-fatty, spicy, vegan and other similar types of filters. The present invention further provides a discount filter. The discount filter filters the foods and restaurants that have discount. The present invention additionally provides an open filter so as to indicate the restaurants that are open. The food ordering application 100 further provides a restaurant or food name filter. In a section of the page, a search box is displayed to the user, where the user can search for the name of the restaurant or the food desired. The food ordering application 100 further provides a food type filter. In this section of the page, a list of food types is displayed as a tree, and by selecting each food type restaurants are displayed which serve foods with selected food types. In step 209, the user can additionally enter taste preferences wherein the taste preferences can be associated with their profile and applied to all or selected searches or be used for the instant search.

In step 211 the food ordering application 100 provides food listings. Food types are groups of complex foods that have common characteristics. By way of example but not limitation, foods such as pizza, sandwiches and hot dogs fall into the category of fast foods and fast food is a food type. Ice cream, cakes and cheesecakes are also included in the dessert category, which is a food type within the context of the present invention. The parameter of food type is employed by the user to search for food. By way of example but not limitation, a user who only wants Italian food selects the Italian group from the list of food types. Subsequently the restaurants information, which includes but is not limited to the restaurant image, the restaurant logo image, the restaurant name, address, and approximate preparation time is displayed for the user. Estimated meal preparation time for each restaurant is calculated based on the average preparation time of all the meals of restaurant. Additionally, the opening or closing status of the restaurant is displayed to the user at this time.

In step 213 categories are provided to the user. For each restaurant three options are displayed including menu, info and reviews. If the user selects the menu, the restaurant menu, which was previously defined by the restaurant agent in menu maker is shown to the user. Each menu can have several submenus. There are three filters available for each menu, including available, discount and healthy. Selection of the available filter allows the user to view all the foods of restaurant that are currently available in the restaurant. Selection of the discount filter allows the user to view all of the foods of restaurant for which a discount is available. Selection of the healthy filter provides a view of only the healthy foods to the user. For example, by selecting pizza from the menu and the healthy filter, only foods from the pizza menu are displayed to the user, which are healthy according to the pre selected health parameters of the user. For each menu, in addition to the filters, there is also an order by option, which orders the foods of each menu for the user according to their healthiness, price or preparation time. For each food in the menu, the color of that food as well as its related icon is displayed. The food ordering application 100 includes three categories, the healthy delicious icon in green color, carefree delicious icon in orange color and unkind delicious in pink color, which are displayed next to its name at the top of the graphical box that displays the food. At the bottom of the graphical box, the price of the food, the preparation time, the average of the feedback stars given to that food. Additionally, if a discount for that food is available that is also displayed to the user.

In steps 215 and steps 217 the present invention will provide restaurants to the user. The info tab displays information about the restaurant. This information includes the name of restaurant, the type of restaurant such as but not by limitation, fast food, Italian, Asian and other similar types. Further displayed are the working hours of the restaurant, the address, and the location of the restaurant on the map. In the reviews section, the average restaurant scores and the number of people scored the restaurant by stars are displayed graphically. Additionally, the user comments about the restaurant along with the number of stars they have provided the restaurant is displayed in this section. In the restaurant menu section, it is possible to select food and add it to the shopping cart. If the user is not logged in, clicking on that food will open a pop-up, which includes a photo of the food with three tabs called food, detail and comment. In the food tab there is a description of that food, the calories of that food and the price of the food. Furthermore, the food ordering application 100 provides a parameter of modifier having two thereof being required and optional. If a required modifier was defined for the food, the add to cart button is disabled until the user selects all the required modifiers. In the detail tab, the ingredients of the food are displayed along with their amounts including categorized by low, medium and large, food types and related food dietaries. In the comment tab, information about user feedback related to this food is displayed. At the top of this section, the average restaurant scores and the number of people scoring by stars are displayed graphically. The user can also see the percentage of user satisfaction from each pre-defined feedback fields in the food ordering application 100.

In step 219, the software application facilitates the process of order processing. At the bottom of a graphical window interface there is a counter that user can use to specify the number of meals. To select and add food to the order, the user selects the add to cart button. After selecting each food, all selected foods, along with the price of each item, are displayed in the shopping cart icon. If the serving time of the selected food is different, for example, the time of serving the food is for breakfast and the user chooses this food at night, the user will receive an error message stating that this food will not be served at this time. By selecting each food, the name of that food is added to the list of selected foods in the shopping cart icon. In the shopping cart, the user can change or delete the number of any of the order items. If the user selects food from another restaurant in addition to the selected food, a message will be shown stating that this order will replace the previous orders, and the previous orders will be removed from the shopping cart icon. At this point, if the user for any reason presses the return button, and performs a new search operation, the previous shopping cart is saved. If the user stays inactive on the same page for a while after choosing a food, or goes to other pages of the site without closing the current page, and during this time, the food ordering time has passed, or the food has run out, or the restaurant has closed, when the user presses the checkout button, and wants to log in, a message stating that the meal time has passed is shown to him, and the checkout page will not open until the user has removed the foods from the cart. But if the time of serving food had not passed, and the food had not finished, and the restaurant was not closed, the food must remain in the shopping cart and by clicking on the checkout button, the food ordering process must be continued. If the user closes the page after adding food to the shopping cart, the user will no longer be able to view the orders in the shopping cart after re-entering the order page, and the order will be deleted. Once the user has selected all the foods they want, clicking the check out button will open a login page. Also, if the user does not have an account yet, on this page, he can click on the register button and register. After registration, this option is given to the user, to save the information entered so far as a profile. An error message is displayed if the user logs in with an account for which the user role is not defined. At this stage, the user can only log in with an account, for which the role of the user is defined.

If the user has logged in, in this case, the order steps are the same as the one that the user has not logged in, with the difference that in this case, because the user logged in after filling his shopping cart, if he logged out of the system for any reason and logged in with the same account again, the shopping cart must be saved and displayed to him. If the user has logged in with another account, or performed the search operation with an un-logged in mode account, the user will no longer be able to view the contents of shopping cart. Furthermore, in case the user is logged in, if after filling his shopping cart, the user logs out of the system for any reason and logs in again immediately with the same account, the shopping cart must be saved and displayed for him, and if the user returns to the system after a period of time from the selection of foods, the availability of selected foods, their serving time, and the opening time of the restaurant should be checked. If the user logs in with another account after logout, or performs a search operation with no login mode, the user will no longer be able to view the contents of shopping cart. If the user is deactivated for a while after adding the desired foods to the cart while the order page is open, when he returns to the page and clicks the checkout button, the availability of foods, serve time, and opening status of restaurant is checked again, and if service is not available, a warning message is displayed to the user, and the checkout page is not opened for the user until the food is removed from the cart. If the user closes the order page after adding the desired foods to the cart and re-enters the order page after a while, and clicks the checkout button, the availability, serving time, and openness of the restaurant must be checked again. Additionally, if service is not possible, a warning message is displayed to the user, and the billing information page is not opened for the user until that food is removed from the cart.

In step 221, the software application of the present invention facilitates payment processing. After the user selects their food and adds the selections to the cart, the user has to check out to finalize it, and at this stage, an invoice is displayed according to the order. The invoice includes the following: subtotal: the sum of the prices of the order item, tax: the tax on each invoice is the sum of taxes on food items, service fee and delivery tax, delivery fee: shipping cost if the order is delivered by restaurant. The delivery cost is calculated according to the user's address, the distance from the user to the restaurant is calculated, and then the delivery fee is determined by the costs that the restaurant declares for each distance. A Service Fee is received when the delivery is done by the operator of the food ordering application 100 and is specified as a percentage of the bill. The user can reward a tip to the courier if the delivery is done by the restaurant or by the third party. The tip is not taxed and is not included in the platform's profit and must be sent in a separate transaction to the courier. An applicable is considered for any of the food items by restaurant, will be reduced from the price of food items. The fee payable by user is calculated according this formula: Total=Subtotal+Tax+delivery fee+Service Fee+Tip−discount. It should be understood that the formula is exemplary and alternate formulas are contemplated within the scope of the present invention.

During the pricing process the screen displays order information for the user. This information includes order type: In this section, the serve type that the restaurant has specified in its profile is displayed to the user and user can select their order to be delivered by restaurant or be picked up by the user. If the user selects pickup, the amount of delivery fee field will be zero, and if the user selects delivery by restaurant, this field will be filled with the amount of delivery fee, which has already defined by the restaurant. A comment box is also shown to the user in this part, so if the user has any specific explanation this field allows for data entry. The user is displayed an address section. In this section, if the user has several addresses, all the addresses are displayed as radio buttons to him. The default user address is also pre-selected. The address with which the user is searching the food is displayed to the user both in text and on the map, and the user can correct it if it is necessary. If the desired address is not available, the user can add the desired address. If the order is a pickup type, the restaurant address is displayed to the user both in text and on a map. An equipment section is provided to the user for interface. In this section, there is an option to add cutlery, which by activating it by the user, the restaurant is obliged to provide the necessary equipment for him. A tip section is further provided to the user in a graphical data entry field. In this section, the user can select the desired tip value. Tip values are displayed as a percentage to the user. In this way, several values offered to the user are displayed: values of 10%, 15% and 20%. The user can select one of these values or enter his desired value. At this time the user is directed to select payment method. In this section, the existing payment methods to the user are displayed. Currently these payment methods include PayPal and credit card, and the user selects one of these methods and enters their card information. Ensuing entering payment information an order summary is provided. In this section, the order summary is displayed to the user to ensure the user the order is correct.

By selecting the payment method and clicking on the place order button, the user will be transferred to the relevant payment portal and the payment operation will be performed by the user and the payment receipt will be emailed to the user. If the payment is successful, the order will be sent to the restaurant. If the restaurant is able to prepare the order according to the current situation, the order will be accepted and the order will go into preparation mode. After the food is ready, if the order is of the delivery type by restaurant, the food will be delivered by the restaurant. After the user receives the order, he can give feedback to the order and record the pre-specified items in the feedback in the form of positive and negative comments for the restaurant itself as well as for each dish in the order. The user can cancel the order after registering the order and successful payment but before the restaurant accepts the order.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A method of facilitating ordering of at least one food item wherein the food item is compliant with health requirements of a user wherein the method comprises the steps of:
accessing a software application, wherein the software application is downloaded to a portable computing device or access via a computing device via web services, said software application configured to execute the method;
registering a plurality of restaurants, wherein an operator of the method registers a plurality of restaurants in order to have menus from the plurality of restaurants available for viewing on the software application;
registering a plurality of user, wherein the operator enrolls a plurality of users to utilize the software application;
entering user profile data, wherein each user will enter personal information into the software application in an account data;
providing a list of dietary options, wherein the software application provides users a list of dietary options;
selecting at least one dietary option, wherein users will select at least one dietary option to be included in their account data;
providing a list of diseases, disorders and allergenic ingredients wherein the diseases, disorders and allergenic ingredients require dietary restrictions;
selecting at least one disease or disorder, wherein users will select applicable diseases or disorders to be included in their account data;
entering taste preferences, wherein users enter taste preferences to be included in their account data;
searching for restaurants, wherein a user will utilize the software application to search for restaurants;
providing a list of restaurants, wherein the software application will provide a list of restaurants that offer food compliant with requirements of the user;
displaying food items to the user, wherein the food items are displayed utilizing three categories, wherein the three categories are displayed in different colors;
selecting at least one food item, wherein the user selects at least one food items from the food items that are displayed;
confirming an order, wherein the software application confirms the order of the at least one food item;
submitting payment, wherein the software application facilitates a payment process for the at least one food item;
preparing the at least one food item, wherein the restaurant will prepare the at least one food item ordered by the user; and
receiving the at least one food item, wherein the user receives the at least one food item.

2. The method of facilitating ordering of at least one food item wherein the food item is compliant with health requirements of a user as recited in claim 1, wherein the three food categories are allowed, restricted and prohibited.

3. The method of facilitating ordering of at least one food item wherein the food item is compliant with health requirements of a user as recited in claim 2, wherein the three food categories are displayed to the user in different colors.

4. The method of facilitating ordering of at least one food item wherein the food item is compliant with health requirements of a user as recited in claim 3, and further including the step of providing a discount filter, wherein the user can select the discount filter to be displayed food items that have a discount available.

5. The method of facilitating ordering of at least one food item wherein the food item is compliant with health requirements of a user as recited in claim 4, and further including the step of providing a food type filter, wherein the user can utilize the food type filter in order to impact food items that are displayed to the user.

6. The method of facilitating ordering of at least one food item wherein the food item is compliant with health requirements of a user as recited in claim 5, and further including the step of providing a meal prep time filter, wherein the user is displayed an amount of time a food item will require to be prepared.

7. The method of facilitating ordering of at least one food item wherein the food item is compliant with health requirements of a user as recited in claim 6, and further including the step of listing food quantity categories, wherein the software application lists food quantity categories for each food ingredient in three quantity categories of low, medium and large.

8. The method of facilitating ordering of at least one food item wherein the food item is compliant with health requirements of a user as recited in claim 7, and further including the step of providing a restaurant status, wherein the software application lists to the user an open or closed status to the user.

9. The method of facilitating ordering of at least one food item wherein the food item is compliant with health requirements of a user as recited in claim 8, and further including the step of providing three food designations to a user, wherein the food designations are correlated to parameters in the account data of the user.

10. The method of facilitating ordering of at least one food item wherein the food item is compliant with health requirements of a user as recited in claim 9, wherein the three food designations are healthy delicious displayed in green, carefree delicious displayed in pink and unkind delicious displayed in pink.
